(19) United States
(12) Patent Application Publication
(10) Pub. No.: US 2012/0011015 A1
(43) Pub. Date: Jan. 12, 2012

(54) System for Managing Relationships with Constituents on Social Networks using CRM (Constituent Relationship Management) Systems

(75) Inventors: Sunil Singh, Walnut Creek, CA (US); Pankaj Sharma, Fremont, CA (US); Sidharth Malhotra, Mason, OH (US); Doug Havens, (US)

(73) Assignee: HOBSONS INC., Cincinnati, OH (US)

(21) Appl. No.: 13/107,452

(22) Filed: May 13, 2011

Related U.S. Application Data
(60) Provisional application No. 61/334,209, filed on May 13, 2010.

(51) Int. Cl. G06Q 99/00; G06Q 30/00

(52) U.S. Cl. 705/26.1; 705/319

(57) ABSTRACT

A Social Network Application enables institutions (such as colleges and universities or institutions in other business verticals) to communicate and engage with their constituents (prospects, applicants, students, faculty, alumni, etc) on Social Networks (e.g.: Facebook.com, MySpace.com. Orkut.com, etc) by providing a platform through which constituents may find and connect with each institutions and friends on these networks, and through which institutions may answer questions from constituents, push or allow constituents to pull personalized content within the Social Network, register constituents for online and in-person events and interviews, and otherwise communicate through various channels (e.g.: RSS, SMS/text messaging, phone, etc.). The invention provides an interface that enables the aforementioned to be managed from within a CRM system at the institution that is not otherwise related to the Social Network.

### CROSS REFERENCE TO RELATED APPLICATION

The present invention claims priority to U.S. Ser. No. 61/334,209 filed May 13, 2010, the disclosure of which is hereby incorporated herein by reference in its entirety.

### FIELD OF THE INVENTION

This solution pertains to “Constituent Relationship Management on Social Networks” in the field of CRM (‘Customer Relationship Management’ or ‘Constituent Relationship Management’) in general and CRM for Higher Education in particular.

### BACKGROUND OF THE INVENTION

Institutions understand that they need a presence on social networks, but have no time or resources to monitor, publish content, and promote themselves on the social networks. Even though these social networks provide a platform for creating a page dedicated to the institution, there is no easy way to capture leads from social networks and bring these into an institutional CRM system for further engagement. Some social networks also provide an application (App) platform that can be leveraged to create interactions with social network users, and some organizations have undertaken to create custom Apps for those persons interested in their organization. However, a typical user cannot be expected to add and monitor dozens of apps from numerous institutions that may be of interest to the user. In this context, the term “user” refers to a constituent or customer of a CRM system. A good example would be a student planning to apply to colleges for admissions; expecting such a prospect to interact with, e.g., 10 institutes using 10 individual Apps is a clear obstacle in efficient CRM interactions between those institutes and the prospect.

The Inigral service, which is publicly available, can be used to build an application for a school, but this can result in the unwieldy result for prospects described above. The Inigral service does not allow a user to have one Application for all of their alumni relationships (multiple institutions) and does not account for the possibility of different relationships to different schools (applicant vs. alumnus, etc.)

The assignee of the present application, Hobsons Inc., previously developed a FACEBOOK Application that would allow students to find college information for various colleges, and add colleges of interest to a personal list. However, this system provided no interactivity, and was not generally successful.

USNews has released a FACEBOOK Application with similar features to that provided by Hobsons Inc.

Explore U (aka Education Connection) provides a service that helps users to evaluate schools to match a user's needs, and includes search functions to identify schools based on educational background and area of interest. A user can also submit profile information to view schools matching search criteria, and then submit a request for information from a specific school, which would then make contact via e-mail, telephone or a mailer.

CampusBuddy.com provides an application that connects FACEBOOK users with a campus, classes and classmates, and provides professor and grading records, and provides a calendar view for coursework. However, no linkage is provided outside of the FACEBOOK system.

Cramster.com provides a scheduling-sharing application on FACEBOOK that allows users to view school activities of friends, form study groups and share notes, but has similar limitations.

Coursehero.com provides an Application with similar functions, as does Blackboard.com.

Another Application is provided by Podclass.com; this Application permits course management information from the open source Moodle software to be interfaced into FACEBOOK.

### SUMMARY OF THE INVENTION

One aspect of the present invention provides an Application for a Social Network, allowing an interface to the Social Network by participant institutions in a given vertical market. Examplary vertical markets include Higher Education, Banking, Investment, Airlines, and the like. The interface is built to contain public domain facts regarding the institutions in the vertical market, for review by market participants, and the interface also provides an electronic connection to a constituent relationship management system of at least one institution, where the relationship management system is unrelated to the Social Network. The Application thus frees an institution of the burden of forming a customized Social Network Application and leverages the existing relationship management (CRM) system of the institution in communicating with market constituents having interest in the institution.

In the described detailed embodiment, utilizing the Application, constituents can search for the institutions that they are interested in and add to those institutions to their customized version of the Application.

In this embodiment, while adding the institution, constituents can specify their current or intended relationship with the institution, their preferences on how they can be contacted and other domain specific information. For example: In case of a University, a constituent may be identified as Applicant, Alumni, Faculty, and may identify details such as the departments and/or programs of interest. In the case of an Airline, a constituent may be identified as a Traveler, Pilot, Ground Staff, etc., and may provide details location, frequent destinations, etc. Based on the above data, through the Application, Social Network users can find similar users (e.g.: other users applying to undergraduate program of a college).

In the detailed embodiment described below, through the interface to the relationship management system of one participant institution, when a user adds an institution, a corresponding record is created in the institution's CRM system or is matched up to an existing record already in the system. Thereafter, based on a user's profile and stated relationship to an institution, etc., using their CRM system, the institution can deliver custom content (text, audio, video etc) to the user in the Social Network using Push or Pull channels. For this purpose the Application may provide a content page in the Application within the context of Institution, RSS subscription feeds, SMS/Text Messages, connections to the Social Network's messaging, or facilitate the use of Social Network contact information for emails or a phone call.

In the detailed embodiment described below, within the Social Network Application, a user can ask questions to an institution within the network and receive an immediate answer. These answers are obtained and managed using the CRM system of the institution. Also using its CRM system, an institution can promote and/or invite the user to in-person or on-line events and or interviews. Users can search for upcoming events, accept invitations, RSVP to events or interviews, or even attend online events or online chats by simply clicking on link provided within the Social Network Application.

In the embodiment described, at an institution's discretion, a social network user can start a transaction from within the social network. (Examples: for a University—a user may start an on-line application for admission, for an Airline—a user may start an air ticket purchase, for a Bank—a user may request a service such as statement, new check books). The institution can poll social network users for feedback on any topic within or outside the domain of the institution. The institution may also push segmented information to the users of social network, such as information may be pushed only to constituents interested in a particular department of a university or a particular region of an airline's route map. There can be interaction between segmented departments and the users of social networks independent of the institution.

In accord with principles of the present invention, the application for any Social Network will be accessible through any device or platform, whether stationary or mobile, including, for example, cell phones, PDAs, desktop computers, pad computers, laptop computers, etc.

These and other aspects and attributes of the present invention will become increasingly clear upon reference to the following drawings and accompanying specification.

### BRIEF DESCRIPTION OF THE DRAWINGS

Referring particularly to the drawings for the purpose of illustration only and not to limit the scope of the invention in any way, these illustrations follow:

FIG. 1 is an overview block diagram of an implementation of principles of the present invention.

FIG. 2 is a diagram illustrating the process of adding the Application embodying principles of the present invention, to a constituent's Social Networking identity, and FIG. 2A illustrates an exemplary FACEBOOK Application screen generated during this process.

FIG. 3 is a diagram illustrating the process for searching for a school in one embodiment illustrating principles of the present invention, and FIGS. 3A, 3B, 3C, 3D and 3E are illustrations of exemplary FACEBOOK Application screens, generated during the process of finding and considering facts regarding a school, and connecting with other constituents.

FIG. 4 is a diagram illustrating the process for obtaining answers to questions regarding an institution and following up on queries regarding an institution using an exemplary FACEBOOK Application, and FIGS. 4A and 4B illustrate exemplary FACEBOOK Application screens generated during this process.

FIG. 5 is a diagram illustrating the process for viewing and joining current and upcoming events using an exemplary FACEBOOK Application, and FIG. 5A is an illustration of an exemplary FACEBOOK Application screen, generated during the process of viewing events.

FIG. 6 is a diagram illustrating the process for viewing personalized content and sharing information using an exemplary FACEBOOK Application, and FIG. 6A is an illustration of a personalized FACEBOOK screen generated during this process.

The following description is of the best mode presently contemplated for the carrying out of the invention. This description is made for the purpose of illustrating the general principles of the invention, and is not to be taken in a limiting sense. The scope of the invention is best determined by reference to the appended claims.

### DETAILED DESCRIPTION

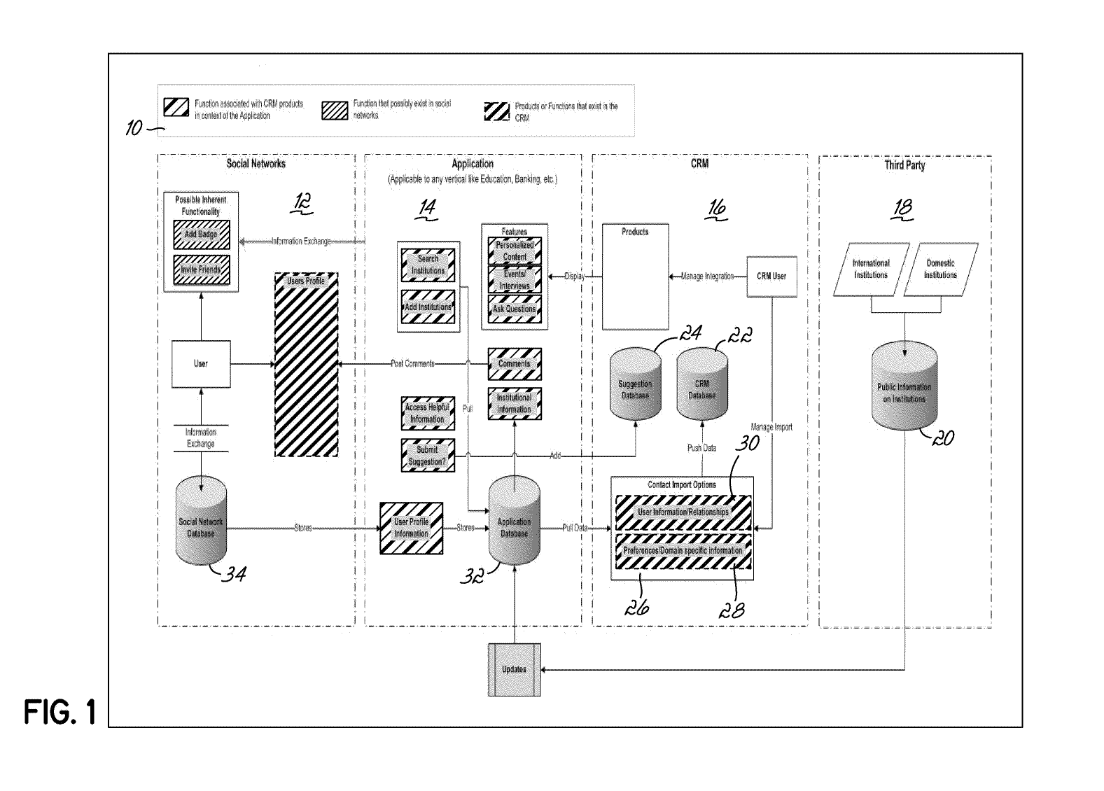

Referring now to FIG. 1, there are illustrated four major components to an exemplary Social Network Application 10 in accordance with principles of the present invention. They are the Social Networks 12 (e.g.: FACEBOOK, MYSPACE, ORKUT, etc.), the Application 14 (different application for each vertical market, such as Education, Finance, Airline, etc.), the institutional CRM 26 (the institution will have its own version of the CRM) and the publicly available Information for institutions of the vertical, available from various third parties 18, whether they use CRM or not. All these entities integrate with each other through a network of servers and databases to deliver the interaction as described herein.

The four primary data components needed for the application to integrate institutions with Social networks are as follows:

A database 20 of Public Information on Institutions containing the publicly available information for domestic and international institutions. This information is updated regularly by the institutions. This database will be integrated and queried to retrieve information.

The CRM 16, which is unique for each of the institutions, and in which the institution manages contact and follow-up information. The institutions may push targeted content to users on social networks based on their available profile information, such as answers to questions and similar data in a CRM Database 22, and the institution will accumulate input from Social Network constituents in a Suggestion Database 24. An Import function 26 will pull data from the Application, such as User information and relationships 30, and Preferences or Domain specific information 28, and push that data to the CRM database 22.

The Application Database 32 will store and manage the application data required to run the application in a social network.

The Social Network's Database 34, which contains all user information and is the property of the social network. The Social Network will manage and maintain the data residing in these databases.

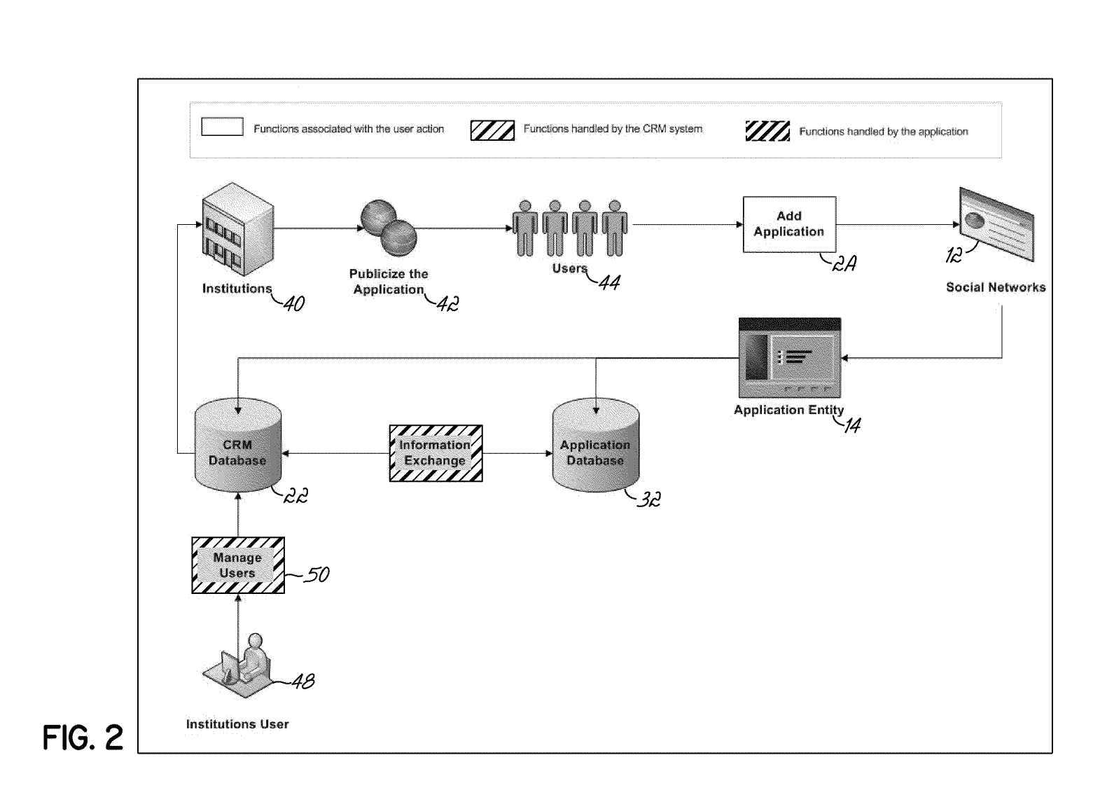

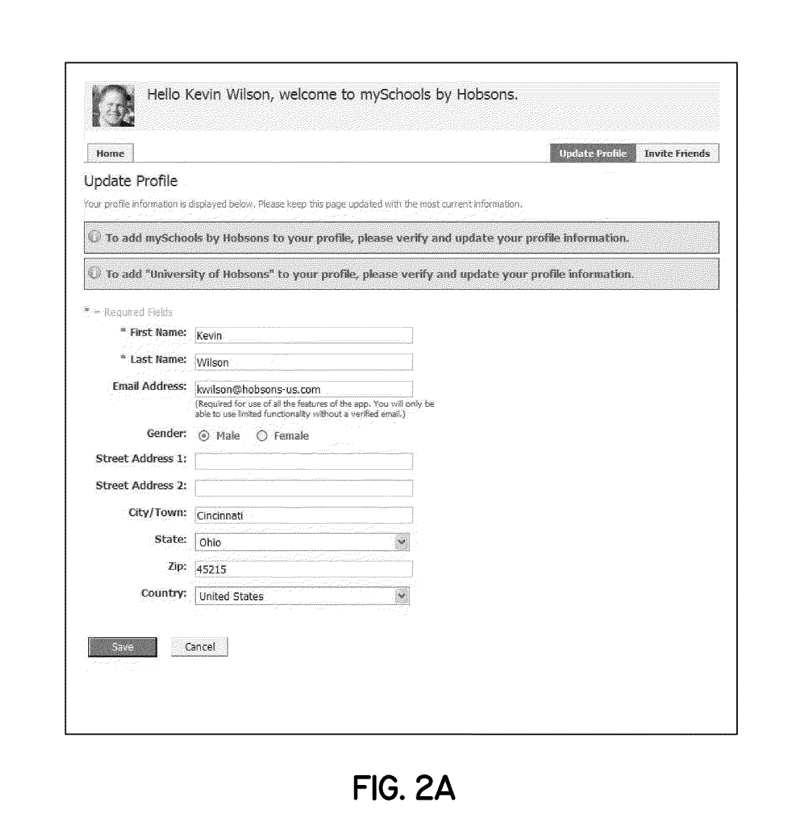

FIG. 2 illustrates that the application will integrate with inherent functionality of a Social Network to allow Social Network users to share/manage the application on their profile (e.g. Share the application with FACEBOOK friends, Add application as a badge on the profile page, etc.). Moreover, the application can be shared by any of the participating institutions within the vertical market that is interested in connecting with users of the Social Network.

After enrollment of institutions, the application can be shared/publicized in the following methods:
An institution 40 can publicize 42 the application, e.g. by sharing a link or reference of the application through mass communication (e.g. mass email, hand-outs, letters, etc.), or institution can share a link or reference of the application through public facing web pages.
The Social Network users 44 can share the application with their friends.

A user 44 adds 46 the application to their profile, thus establishing status as a constituent of the vertical market for the application. See the related screen display in FIG. 2A. This process may involve confirming or potentially extending the user's personal information as needed for proper operation of the Application 14. After a user adds the application, then an institution user 48 may access and manage 50 user information of users that have associated with the institution, via the institutions CRM database and CRM system.

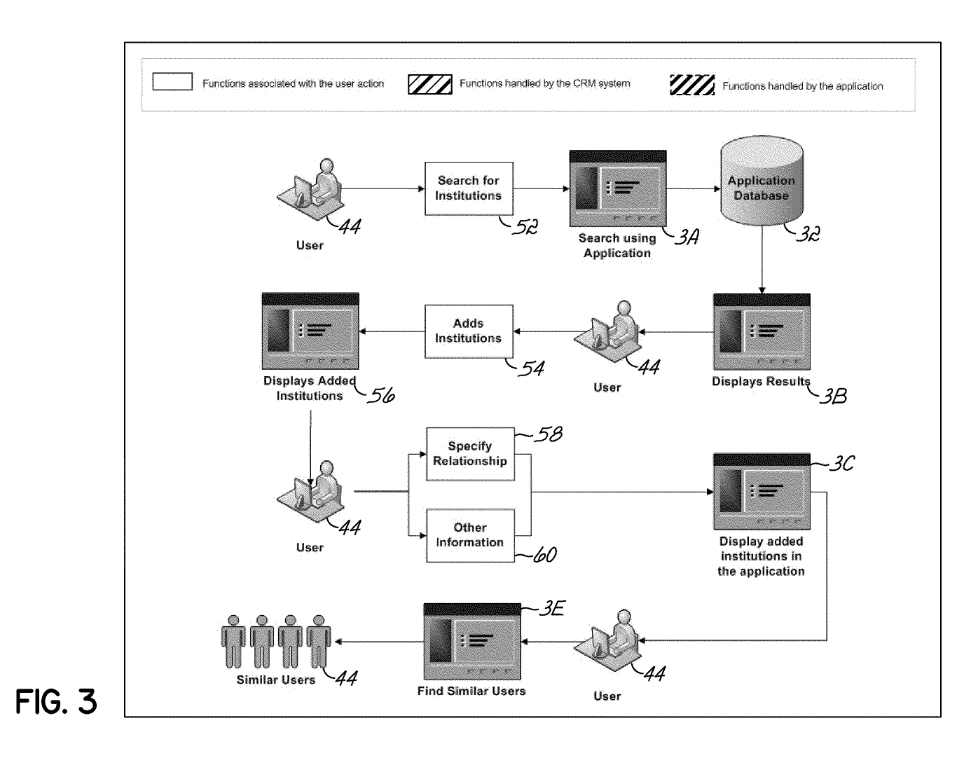

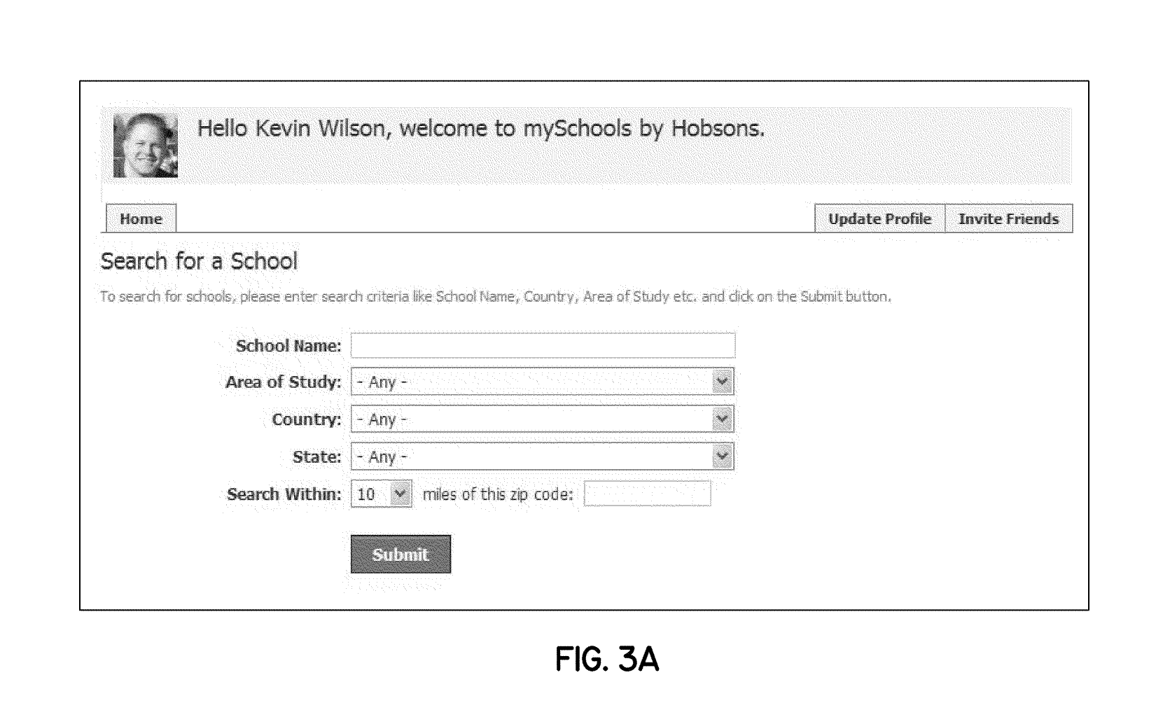

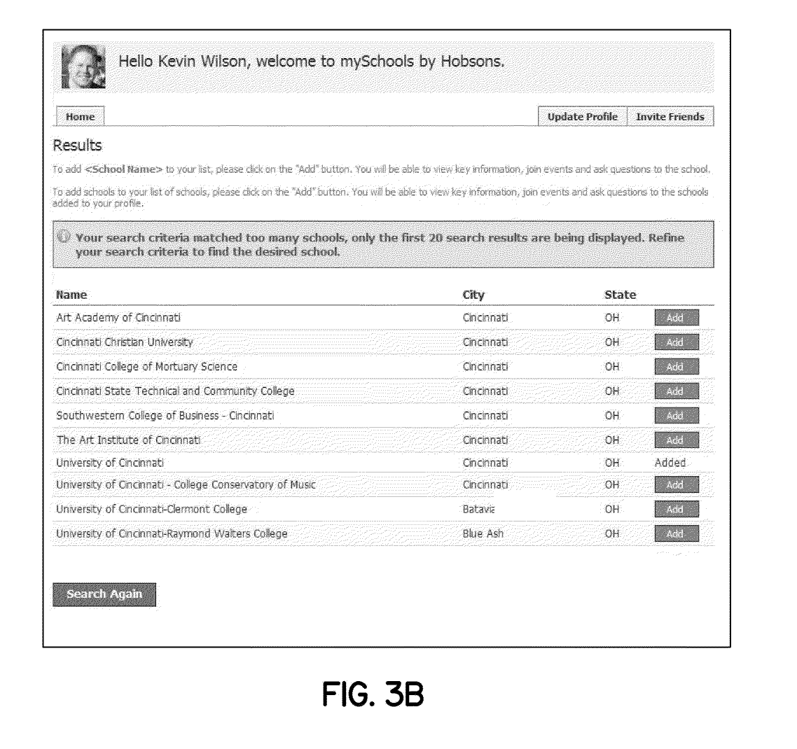

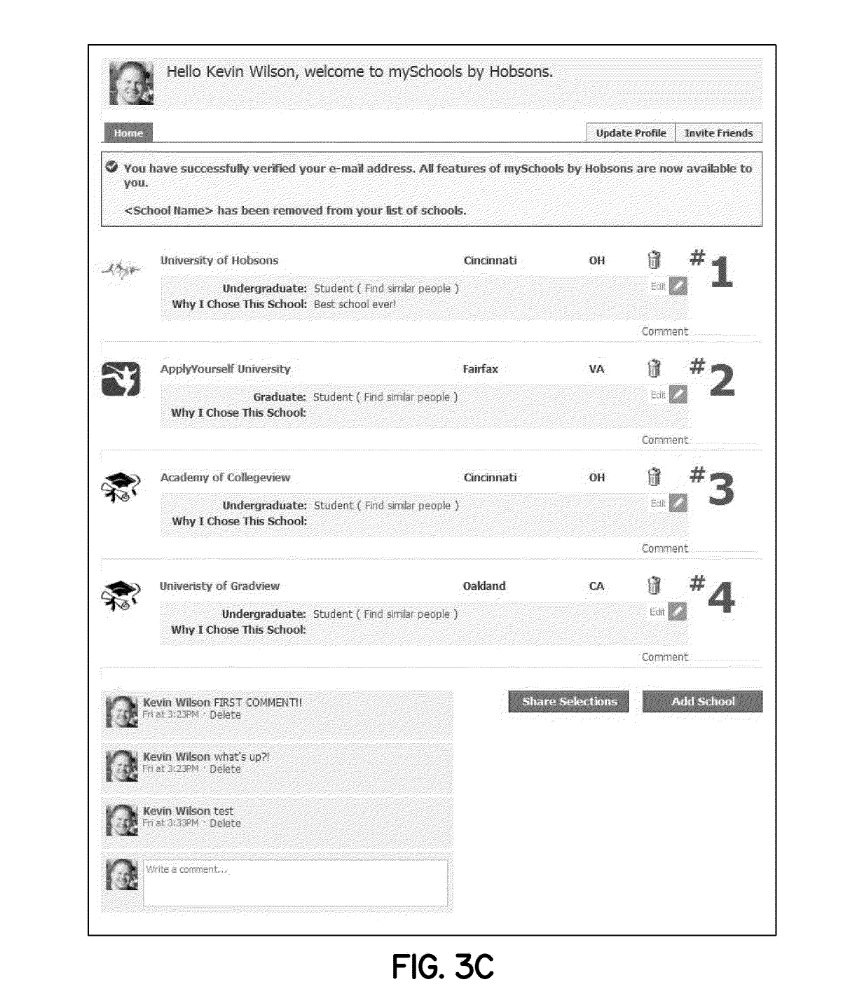

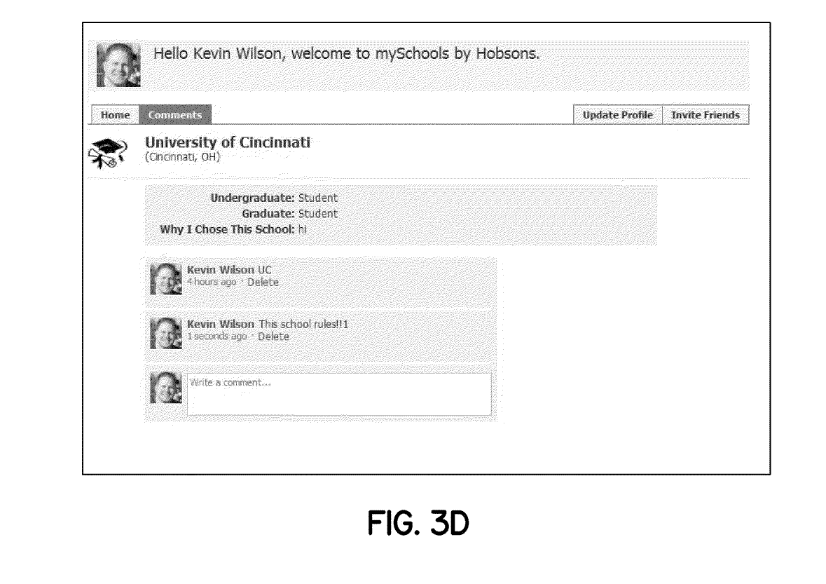

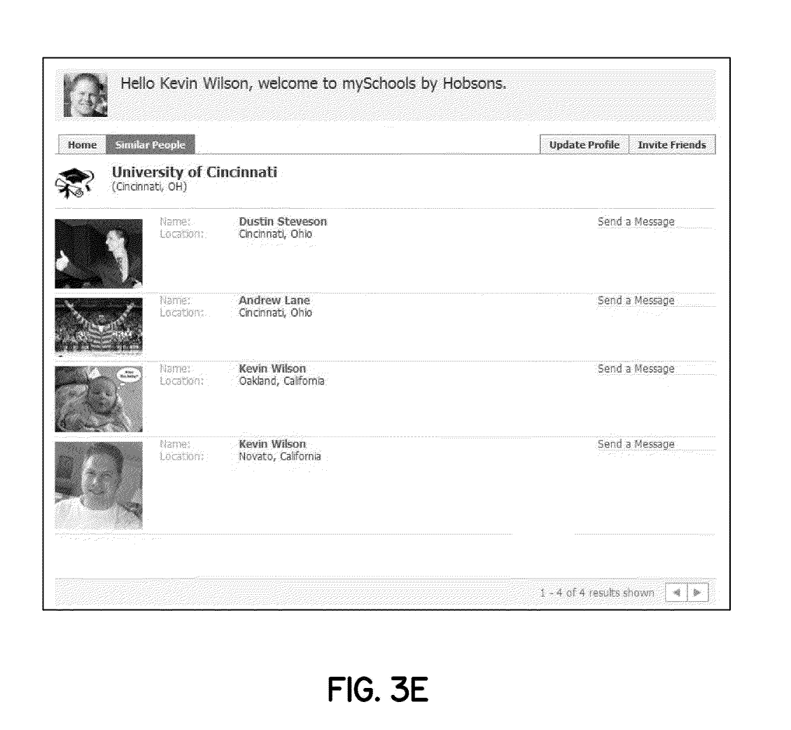

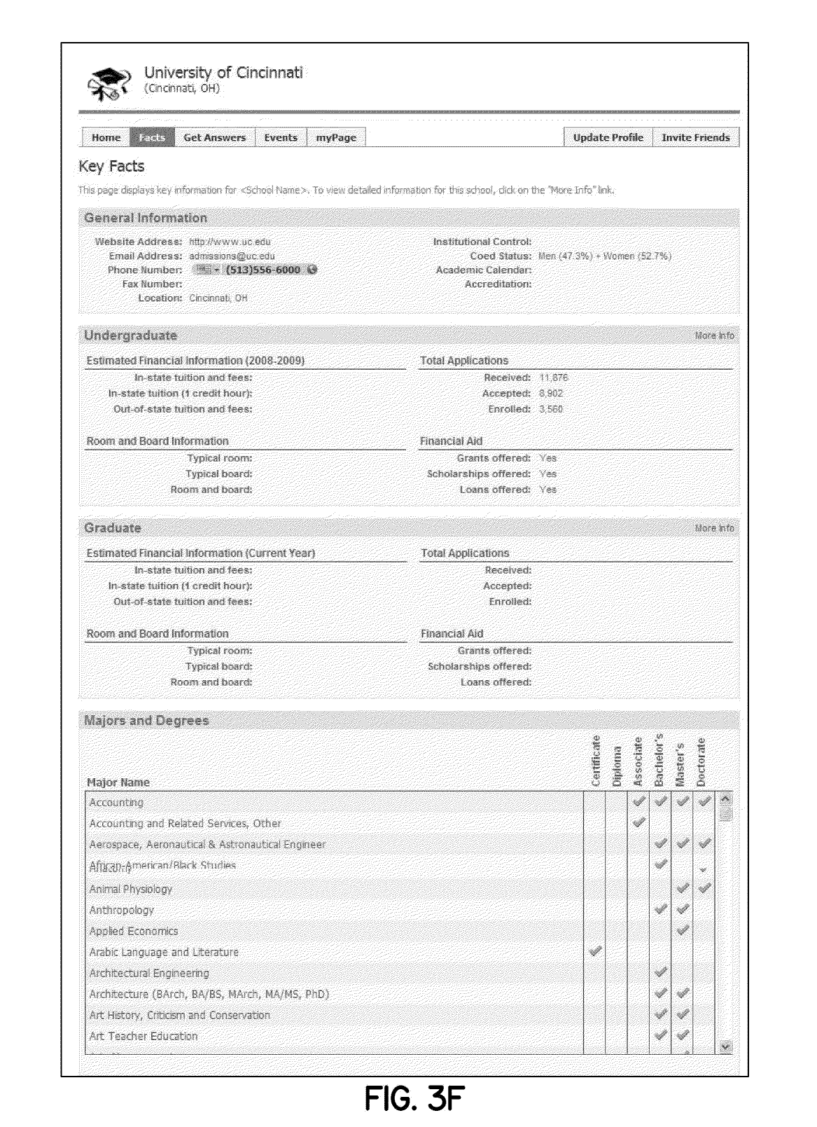

FIG. 3 illustrates the process by which a user 44, through the Application, associates with a given institution. This process begins with the user searching 52 for institutions, by providing a name or a desired attribute (e.g., area of study for an educational market), as illustrated in FIG. 3A. The Application searches the Application Database 32 and provides results. The user obtains a results display, such as seen in FIG. 3B. The user 44 then adds 54 the desired institution(s) to their personal list so that these particular institutions are available within the user's interface to the Social Network Application. In this process, the Application displays an interface 56 to allow the user to determine their relationship 58 with the selected institution, and any other relevant information 60. (For example, in the vertical of Higher Education The interface allows the user to make a selection for Undergraduate and/or Graduate programs). The user can choose to keep this selection private if they would not like their choices to be searchable by other users of the Social Network. The user can edit their relationship with the institution at any given point in time.

Information about institutions added by the user 44 will be displayed together at a home page of the Application, as seen in FIG. 3C. The user 44 can add comments on their list of favorite institutions. The comments entered may be pushed to the users Profile page, Newsfeed and Notifications within the social Network. For example, the user may rank academic institutions by preference as part of a college search.

After associating with an institution, the user can then undertake various activities specific to that institution by changing context from the home page of the Application to the context of a specific institution, as illustrated in FIG. 3D. The user has the option to switch to different divisions of the institution if the divisions are using separate instances of CRMs. If enabled, the following functionality can be available in context of an institution

A Similar People function, illustrated in FIG. 3E, may be used to find other users 44 of the Social Network with the same matching criteria and/or stated relationships for a particular institutions.

Other functions may be available within the context of a specific institution. For example, a Facts function may be available for the institution, as seen in FIG. 3F, in which the user can view key facts about the institution. These may be provided from the Public Information database 20 shown in FIG. 1.

Additional features that may be available within an institution are seen in the tabs 62 on the FACEBOOK page shown in FIG. 3F. These include a Get Answers, Events, and myPage functions, which will now be discussed.

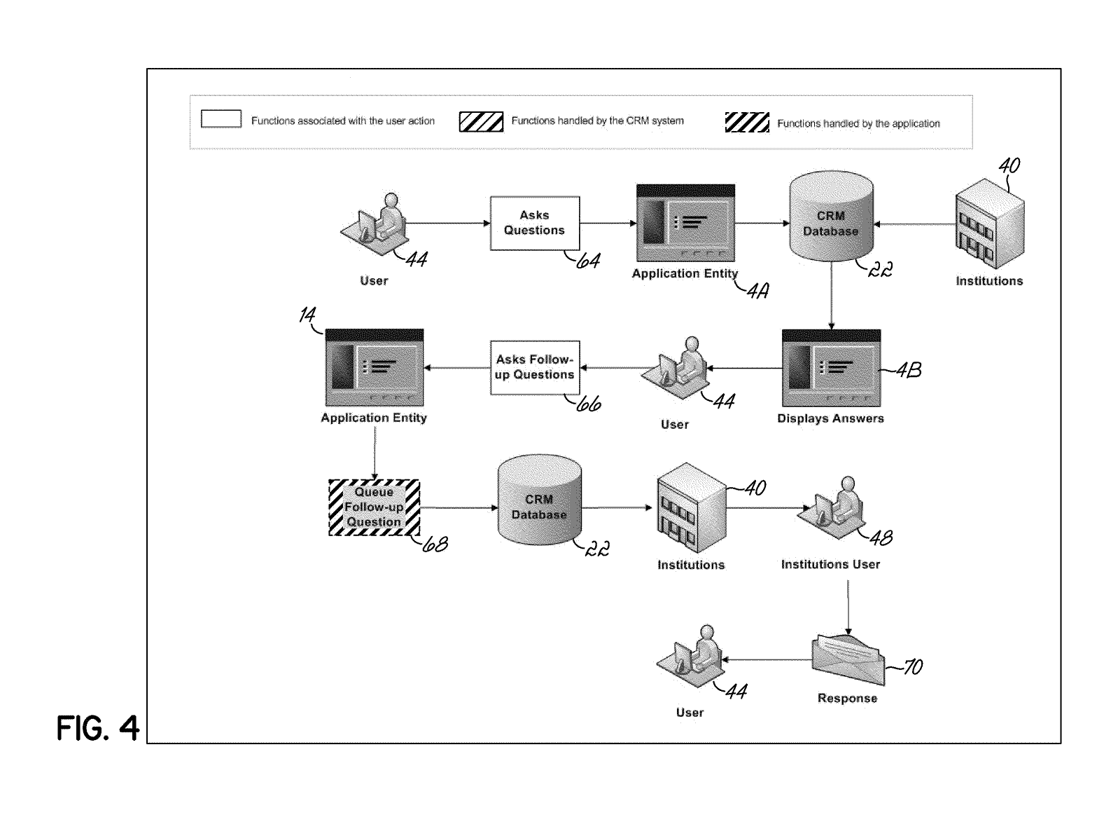

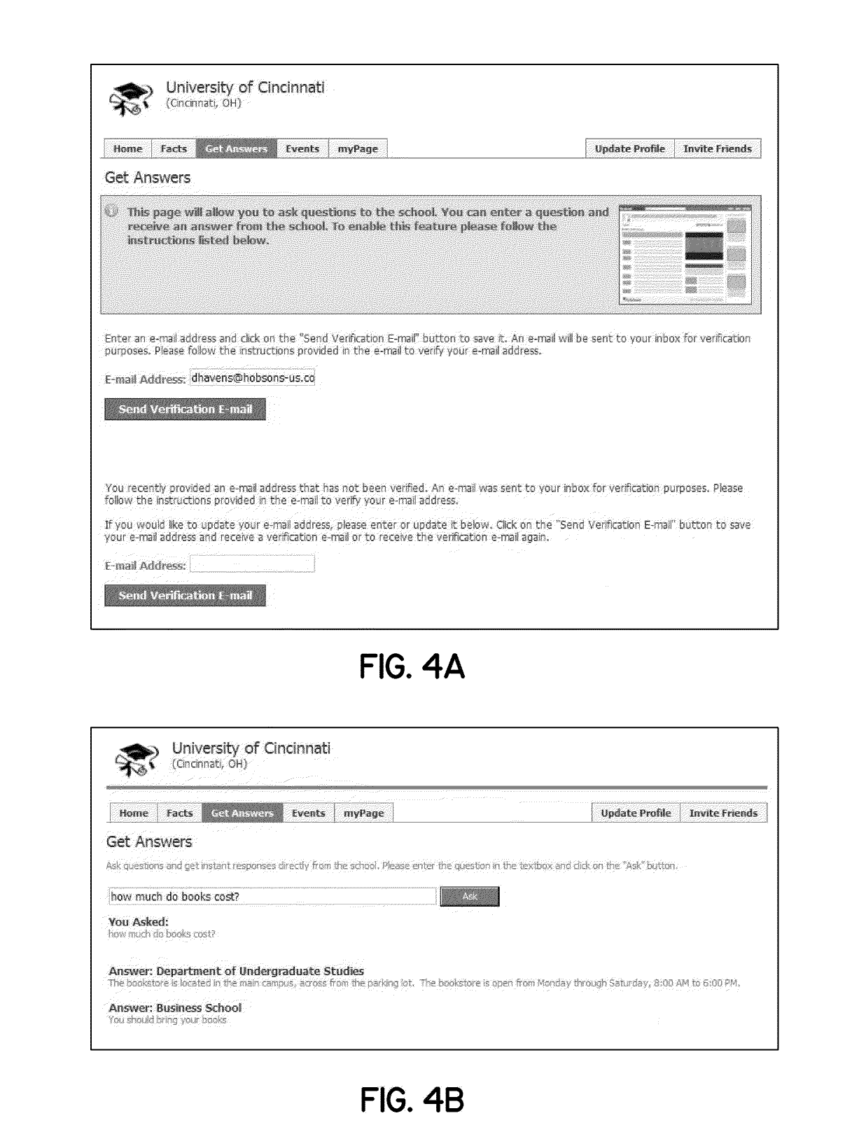

Referring now to FIG. 4, the “Get Answers” feature allows the user to ask questions 64 of the institution, via the Application within the Social Network. This is seen in FIG. 4A. The application will return all matching answers found in the CRM database, as shown in FIG. 4B. If these answers are not on point, or if further information is desired, the user 44 can also ask 66 a follow-up question. As noted above, a knowledgebase of questions and answers is managed within the institution's CRM, and suggestions and followup from the Social Networking application are forwarded by the Application to a queue 68, and then to the institution's CRM database 22, to permit direct interaction between the institution 40 and particularly an institution user 48, who will prepare a response 70 (typically via email) and forward it to the constituent user 44.

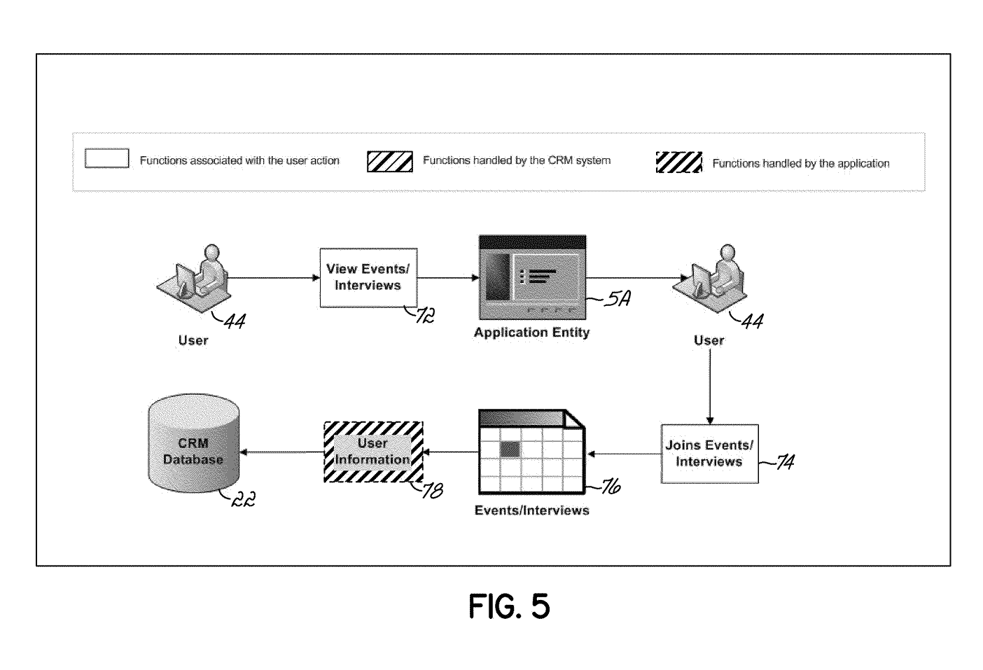

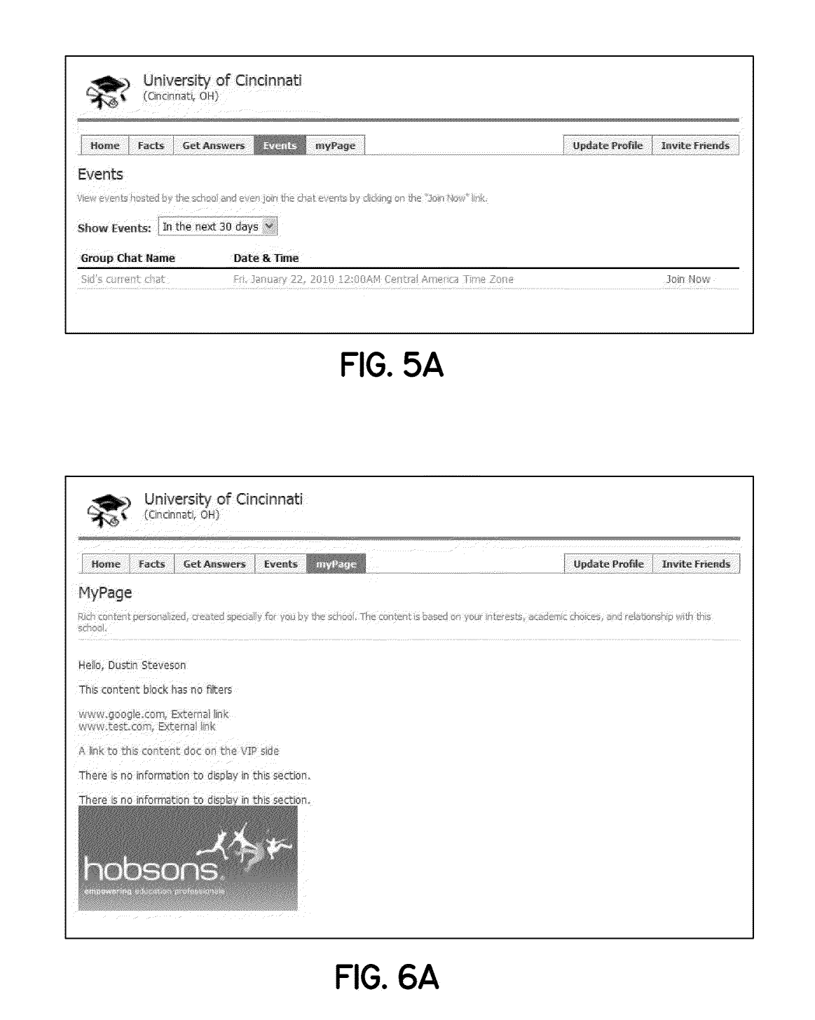

Referring now to FIG. 5, the “Events” feature allows the user 44 to search for and view 72 events in the current or upcoming date. The display of events is seen in FIG. 5A. The user can search within the events or interviews applicable to him/her. The user 44 may also register/join an event 74, choosing a date and time 76 from a calendar, which causes personal information 78 from the Social Network user to be delivered to the institution's CRM database 22 so that the event participation is noted and scheduled at the institution.

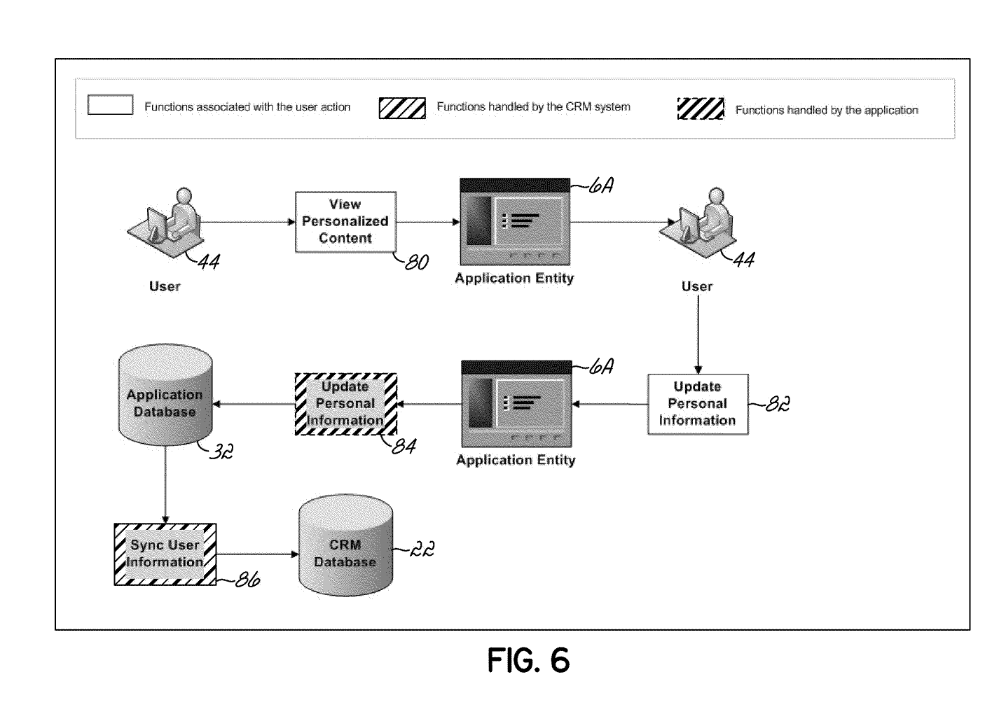

Referring now to FIG. 6, personalization features, aka “myPage”, for an institution allows the user 44 to view personalized content 80 based on the user's Social Network profile, as seen in FIG. 6A. Based on user's profile and stated relationship, etc., using the institution's CRM system, the institution may deliver custom content to the user in the Social Network myPage, using a Variety of Push or Pull channels—for example, the institution may provide a content page in the Application within the context of the institution, RSS subscription feeds, SMS/Text Messages, make contact via the Social Network's messaging, or initiate emails or telephone calls.

At all times, a user has the option to view and update 82 the profile information residing in the Social Network Application. This information is synced with each joined institution's CRM and therefore is updated in their CRM as well, by the delivery 84 of an update of the personal information to the Application database 32, followed by the synchronization 86 of the user information between the Application Data 32 and the CRM Database 22 at the Institution.

In accordance with the preceding explanation, it can be seen that a Social Network application accomplishes numerous features not previously implemented, through integration with the CRM systems of individual institutions. This has been shown through a specific embodiment, but variations and adaptations of the Social Network application in accordance with the present invention, and for particular vertical markets, will suggest themselves to a practitioner of the programming arts.

In accordance with these and other possible variations and adaptations of the present invention, the scope of the invention should be determined in accordance with the following claims, only, and not solely in accordance with that embodiment within which the invention has been taught.

What is claimed is:

1. In a computer system comprising servers and applications and providing a Social Network functionality to users, an application allowing an interface from said computer system to independent computer systems of one or more institutions which compete in a given market, the independent computer systems each comprising at least one server and an application providing a constituent relationship management functionality for an institution, the interface comprising
a database of facts regarding institutions in the vertical market,
an electronic connection from said Social Network computer system to said constituent relationship management computer system of at least one institution,
the electronic connection permitting communication from said constituent relationship management application to users interacting with said Social Network Application, and permitting communication from said Social Network Application to said constituent relationship management application.

2. The application of claim 1 wherein, using the application, a constituent of an institution searches for that institution and adds that institution to the constituent's customized version of the application.

3. The application of claim 2 wherein, as part of adding an institution, a constituent specifies one or more of:
a current or intended relationship with the institution, and
constituent preferences on how they can be contacted, using contact information available from said Social Network functionality.

4. The application of claim 3 wherein the institutions are educational institutions and constituents are identified as one or more of Applicant, Alumni, Faculty.

5. The application of claim 3 wherein the institutions are educational institutions and constituents identify one or more of departments and/or programs of interest.

6. The application of claim 3 wherein the institutions are airlines and constituents are identified as one or more of Traveler, Pilot and Staff.

7. The application of claim 3 wherein the institutions are airlines and constituents identify one or more of location, frequent destinations, and frequent traveler information.

8. The application of claim 1 wherein, using data provided by users, to the application or Social Network functionality, the application identifies users to other users having similar interests in institutions.

9. The application of claim 1, wherein said interface to the constituent relationship management system of an institution, when a user adds an institution to said application, a corresponding record is created in the institution's constituent relationship management system or the user is matched to an existing record already in the system.

10. The application of claim 9 wherein the interface permits an institution using its constituent relationship management system to deliver custom content to a user via the Social Network functionality using push or pull channels.

11. The application of claim 9 wherein the application provides one or more of:
a content page in the application within the context of an institution,
RSS subscription feeds,
SMS/Text Messages,
connections to the Social Network functionality's messaging service, or
the use of Social Network contact information for emails or a phone call.

12. The application of claim 1, wherein said interface forwards a user's questions to an institution's constituent relationship management system and forwards answers thereto from said constituent relationship management server to said user.

13. The application of claim 1, wherein said application provides a user information regarding in-person or on-line events or interviews.

14. The application of claim 13 wherein said interface forwards a user's search for events and responses to events to said constituent relationship management system, and forwards event information and invitations from said constituent relationship management system to a user.

15. The application of claim 1 wherein said interface facilitates transactions by users from within the social network for the request or purchase of services or goods from the institution.

16. The application of claim 1 wherein said application facilitates polling of social network users for feedback on an institution-identified topic.

17. The application of claim 1 wherein said interface permits an institution to push information to the users of social network that match a specific segment of the institution's constituents.

18. The application of claim 17 wherein said segment is constituents interested in a particular department of a university.

19. The application of claim 17 wherein said segment is constituents interested in a particular region of an airline's route map.

20. The application of claim 1 wherein said application facilitates interaction between users of the social network that are constituents of the institution or a segment thereof.
